(19) United States
(12) Patent Application Publication
(10) Pub. No.: US 2007/0029316 A1
(43) Pub. Date: Feb. 8, 2007

(54) Microwavable grill

(75) Inventor: Juan Fernandez, Towaco, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Products of Tomorrow, Inc., Towaco, NJ (US)

(21) Appl. No.: 11/509,418

(22) Filed: Aug. 24, 2006

Related U.S. Application Data
(60) Provisional application No. 60/810,016, filed on Jun. 1, 2006.

(51) Int. Cl. H05B 6/80

(52) U.S. Cl. 219/730

(57) ABSTRACT

A microwavable cooking apparatus is disclosed. The apparatus may contain one or more cooking surfaces to, among other functions, cook foodstuffs in a microwave oven in a variety of ways, including grilling, griddling, baking, browning, crisping, and steaming. The cooking surfaces may be composed of any one of a variety of cooking plates, each having different surface profiles. for different modes of cooking. Such cooking plates may be detachable and interchangeable. Springs may be included, which permit movement of the cooking plates. The apparatus may also be utilized while being situated in both horizontal and vertical orientations. In addition, the apparatus may include features to facilitate these various uses. Furthermore, several attachments may be operable with the apparatus in order to offer even more functionality.

### CROSS REFERENCE

This present application claims the benefit of U.S. Provisional Patent Application 60/810,016, titled MICROWAVABLE GRILL, filed on Jun. 1, 2006, the disclosure of which is hereby incorporated herein by reference.

### BACKGROUND OF THE INVENTION

The present invention relates to a microwaveable cooking apparatus, and more particularly, to a microwaveable cooking apparatus capable of cooking food in a variety of ways, including grilling and steaming.

Currently, there exist several microwaveable cooking apparatuses on the market. These apparatuses typically consist of freestanding components which are capable of containing food, and which may be placed into a conventional microwave oven. Such apparatuses cook food by including a cooking surface, which contains a material that reaches a high temperature when it absorbs microwave energy. Thus, these apparatuses take advantage of both the quick cook time provided by microwave cooking and the prevalence of the microwave in our society.

Heretofore, such microwaveable cooking apparatuses have not been able to adequately brown the food, such that it is fully cooked and crispy. Rather, most apparatuses employ only one cooking surface, and their use tends to leave the food exposed to the microwave energy, which results in less than ideal food quality. In many cases, the use of such cooking apparatuses may result in prepared food that is no different than food cooked in a microwave without an additional apparatus. For instance, some microwaved foods are left overly moist and/or soft, while others are left very dry and chewy, with bland taste and little to no color. Other apparatuses may utilize lids to cover a cooking surface, but such apparatuses tend to trap the water evaporating from the food and render such food even soggier. Another drawback of apparatuses with lids is that, over time, repeated contact between the lid and the apparatus may create chips in the surface material. As a result of the chipping, the underlying metal material is exposed, which creates arcing problems when energized in a microwave oven. Finally, still further apparatuses, which utilize two cooking surfaces, are known. However, the two cooking surfaces are typically arranged in a horizontal fashion, which tends to create an uneven concentration of microwave energy and often results in uneven cooking of the food.

Therefore, there exists a need for a microwaveable cooking apparatus capable of suitably cooking food in a variety of different ways.

### SUMMARY OF THE INVENTION

In accordance with an embodiment of the present invention, a microwavable cooking apparatus is provided. Such apparatus may be placed into a microwave oven and, when energized by the microwave energy, cooks the contained foodstuffs. It may be utilized to grill, griddle, bake, brown, crisp, steam, cook or otherwise heat-up foodstuffs, such as meat, fish, and vegetables, among others. It is contemplated that the present apparatus may also be particularly effective at making panini sandwiches, melts, pocket sandwiches, and toast, among other specific types of dishes. It is contemplated that an apparatus in accordance with the present invention may allow all or only some of the above-noted functions.

In one embodiment of the present invention, the microwavable cooking apparatus may utilize a single cooking surface to cook a variety of foods in a variety of manners. Such single cooking surface may be composed of any one of a variety of cooking plates, each having a different surface profile. For instance, the surface of one plate used for grilling may include a series of raised, parallel ridges, while the surface of another plate used for griddling may be a substantially flat surface. A variation on the griddling plate may include a raised edge along the perimeter, forming a pan, which may be used for similar functions to that of an ordinary kitchen pan. Additionally, other patterned plates may be provided, including a waffle plate, which may include a gridded arrangement of raised protrusions, and a pancake plate, which may include a raised circular ridge, for retaining the batter. Each plate may further include a recessed channel along the perimeter of such plate, for collecting grease and other liquids emitted from the cooking food. In order to assist the cooking liquids in reaching the channel, any or all of the cooking plates may include a substantially convex surface. The level of curvature in the convex surface may vary. Additionally, any or all of the cooking plates may be coated with a non-stick surface material, such as polytetrafluoroethylene (“PTFE”) , commonly sold under the brand name TEFLON® by E. I. DuPont de Nemours and Company. Other similar non-stick materials often employed by many household cooking apparatuses may alternatively be used.

The present embodiment may further include a concave housing member, and any one of the aforementioned cooking plates may be detachably mounted inside such housing member. The housing member may also include a plurality of feet, which may raise the apparatus off of the surface on which it is resting so that the microwave energy may better contact the bottom surface of the apparatus.

Each of the cooking plates may be composed of a microwave reflective material, which may prevent the microwave energy from directly contacting the cooking food through such plate. Additionally, each of the plates may further include a heating element, composed of microwave absorptive material, which is affixed to the underside of such plate such that the heating element is located between the cooking plate and the housing member. Such heating element preferably, when struck by microwave energy, converts such energy into heat. In this manner, the generated heat is preferably transferred through the cooking plate to the foodstuffs in contact with such plate, where such heat may assist in the cooking of the foodstuffs. In order to allow the microwave energy to strike the heating element, the aforementioned housing member may be composed of microwave transparent material.

In order to perform certain functions, the microwavable cooking apparatus of the present embodiment may also include a lid. The lid may be adapted to engage a rim disposed on either the cooking surface or the housing. An insulating ring may also be provided, which ring is affixed to either the perimeter of the lid or the upper surface of the rim. Such ring is preferably configured in such a way that direct contact between the lid and the rim is prevented while the lid is engaging the rim. The ring may also create an airtight seal along the length of its engagement.

The aforementioned lid is preferably composed of a microwave reflective material, which may prevent the microwave energy from directly contacting the cooking food while the lid is being used. The lid may further include at least one vent hole. In an alternative embodiment, there may be included a means for adjusting the opening of the vent holes. Many different means for adjusting the opening of the vent holes may be provided, as would be apparent to those of ordinary skill in the art. For instance, a turning plate may be provided, which may be adapted to selectively cover or uncover the vent holes. In order to perform a steaming function, a steaming rack may be included in the present embodiment, which rack may be configured to sit on the cooking surface.

In another embodiment of the invention, the microwavable cooking apparatus may utilize two cooking surfaces. As in the previously described embodiment, each cooking surface may be composed of any one of a number of different cooking plates. Such cooking plates may include any or all of the features described above, including surface profiles, recessed channels, or a non-stick coating. Such cooking plates may also be mounted inside concave housing members such that heating elements are located between the cooking plates and the housing members. Such housing members may be adapted to oppose one another such that an interior portion is defined thereby and such that the two cooking surfaces are disposed within the interior portion in substantially parallel planes. This orientation preferably permits each of the cooking surfaces to contact opposite sides of the inserted foodstuffs during cooking.

In one alternative aspect of a preferred embodiment of the invention, one or both of the cooking plates which comprise the cooking surfaces may be detachably mounted to the housing members. In another alternative aspect of the invention, one of the cooking plates may be fixed to the other cooking plate or to the respective housing member by springs, or some other similar device, capable of allowing said plate to move in a direction perpendicular to the other plate. In this way, the movable cooking surfaces may maintain contact with enclosed foodstuffs of different sizes and shapes. Such springs may also apply a desirable amount of pressure to the cooking foods, which may be particularly useful in the preparation of certain foods, such as, for example, panini sandwiches.

In another alternative aspect of a preferred embodiment, the microwavable cooking apparatus may be utilized while being situated in both horizontal and vertical orientations. In the vertical orientation, the microwave energy may be more evenly distributed over both cooking surfaces. A support base may be utilized to support the apparatus during cooking in this vertical orientation. Preferably the support base may include a drip tray. Such drip tray may be integrally formed with the support base, or the tray may be removable and adapted to engage the support base. Preferably, such drip tray may collect expelled grease and other liquids emanating from the cooking food. In order to direct the liquids into the drip tray, the housing members may define an opening, which is preferably positioned above such drip tray.

In another aspect, a means may be provided for adjusting the gap between the housing members. For instance, such means may include a ratcheting mechanism connected to the support base. Alternatively, the ratcheting mechanism may be connected to the housing members. In another alternative, a slidable adjustment mechanism may be provided.

Preferably, one or both of the housing members includes a plurality of feet, as in the single cooking surface embodiment, which may raise the apparatus off of the surface on which it is resting while the apparatus is being utilized in the horizontal orientation.

In another aspect of a preferred embodiment, both housing members may be entirely separated from one another. In this manner, each half of the apparatus may be used separately in a manner similar to the single cooking surface embodiment. A lid, as in the previously described embodiment, may also be provided. Such lid is preferably adapted to engage either half of the apparatus, after the housing members have been separated. The lid may be adapted to engage a rim disposed on either the cooking surface or the housing. Similarly, the aforementioned feet may be situated on one housing member or the other, or both.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a perspective view of a microwavable cooking apparatus in accordance with one aspect of the present invention.

FIG. 2 is a side cross sectional view of the apparatus of FIG. 1.

FIG. 3 is an enlarged cross sectional view of one section of the apparatus of FIG. 2.

FIG. 4 is a perspective view of a support base in accordance with one aspect of the present invention.

FIG. 5a is a perspective view of the microwavable cooking apparatus of FIG. 1 disposed within the support base of FIG. 4.

FIG. 5b is a side view of the microwavable cooking apparatus of FIG. 5a, with hidden portions shown in phantom.

FIG. 6 is a perspective view of a support base in accordance with an alternative embodiment of the present invention.

FIG. 7a is a perspective view of the microwavable cooking apparatus of FIG. 1 disposed within the support base of FIG. 6, with a gap shown between the housing members.

FIG. 7b is a top view of the microwavable cooking apparatus and support base configuration of FIG. 7a.

FIG. 8a is a perspective view of the microwavable cooking apparatus of FIG. 1 disposed within the support base of FIG. 6, in which there is no gap between the housing members.

FIG. 8b is a top view of the microwavable cooking apparatus and support base configuration of FIG. 8a.

FIG. 9 is a perspective view of the microwavable cooking apparatus of FIG. 1 in a different orientation.

FIG. 10 is a perspective view of the microwavable cooking apparatus of FIG. 1 with one housing member removed.

FIG. 11 is a perspective view of the microwavable cooking apparatus of FIG. 10 with a cooking plate removed.

FIGS. 12a to 12c are perspective views of the microwavable cooking apparatus of FIG. 10 demonstrating a method of installing and removing a cooking plate in accordance with one embodiment of the present invention.

FIG. 13 is a top view of a cooking plate having a griddle surface profile in accordance with one aspect of the present invention.

FIG. 14 is a perspective view of a cooking plate having a grill surface profile in accordance with one aspect of the present invention.

FIG. 15 is a perspective view of a cooking plate having a pancake surface profile in accordance with one aspect of the present invention.

FIG. 16a is a side cross sectional view of the microwavable cooking apparatus of FIG. 1 in which the cooking plates of FIG. 15 are installed.

FIG. 16b is an enlarged view of the cross sectional view of FIG. 16a.

FIG. 17 is a side section view of the microwavable cooking apparatus of FIG. 16a in accordance with an alternative embodiment.

FIG. 18 is a perspective view of a cooking plate having a waffle surface profile in accordance with one aspect of the present invention.

FIG. 19 is a side section view of a cooking plate having a convex surface profile in accordance with one aspect of the present invention.

FIG. 20 is a perspective view of a microwavable cooking apparatus in accordance with an alternative embodiment of the present invention in which a steaming rack is included.

FIG. 21 is a perspective view of the bottom of the steaming rack of FIG. 20.

FIG. 22 is a perspective view of the microwavable cooking apparatus of FIG. 10 including a lid.

FIG. 23a is a side cross sectional view of the microwavable cooking apparatus of FIG. 22.

FIG. 23b is an enlarged view of the cross sectional view of FIG. 23a.

FIGS. 24a to 24c are perspective views of the microwavable cooking apparatus of FIG. 22 demonstrating the operation of the vent hole adjusting means.

### DETAILED DESCRIPTION

In describing the preferred embodiments of the invention illustrated in the appended drawings, specific terminology will be used for the sake of clarity. However, the invention is not intended to be limited to the specific terms used, and it is to be understood that each specific term includes all technical equivalents that operate in a similar manner to accomplish a similar purpose.

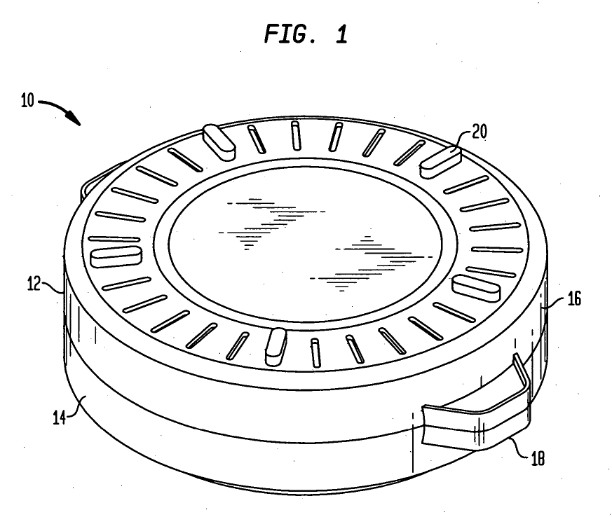

FIG. 1 depicts a perspective view of a microwavable cooking apparatus 10 in accordance with a preferred embodiment of the invention. The apparatus 10 preferably includes a first housing member 12 and a second housing member 14. The housing members may be substantially concave in shape and may be constructed of microwave transparent material, such as high temperature resistant polymer. Suitable materials include: polysulfone (PSU), sodium polystyrene sulfonate (SPS), bulk molding compound (BMC), or polyetherimide (PEI). The exterior surface 16 of either or both of the housing members may also include a plurality of handles 18 disposed thereon, to provide for easier carrying of the apparatus 10. Further, the exterior surface 16 of either or both of the housing members may include a plurality of feet 20 disposed thereon. Such feet 20 preferably raise the apparatus off of the surface on which it is resting so that the microwave energy may better contact the bottom surface of the apparatus. The feet 20 may also prevent damage to the surfaces within a microwave.

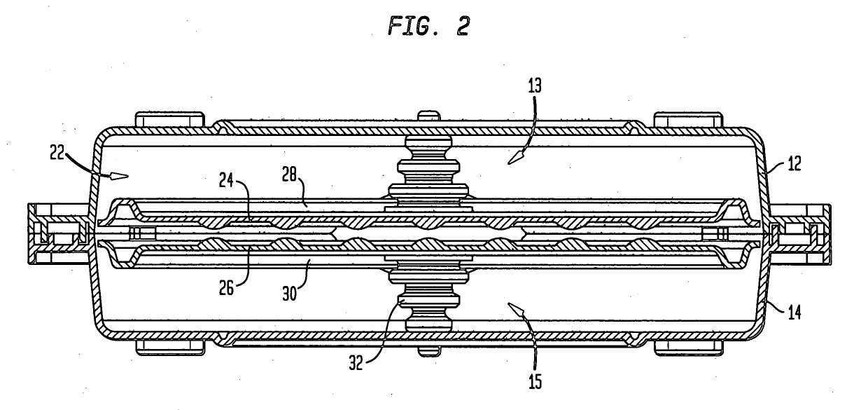

FIG. 2 is a side cross sectional view of the microwavable cooking apparatus 10 discussed above. The second housing member 14 is adapted to oppose first housing member 12 such that an interior portion 22 is defined thereby. Disposed within such interior portion 22 are a first cooking plate 24 and a second cooking plate 26. The first cooking plate 24 is disposed within a first concavity 13, defined by the first housing member 12, and the second cooking plate 26 is disposed within a second concavity 15, defined by the second housing member 14. Such cooking plates are preferably circular and constructed of microwave reflective material, such as metal. Suitable materials include: aluminum, steel, or an alloy, among others. All such metal surfaces may also be coated with an insulating material, such as a mineralized paint, to prevent arcing. Additionally, the coating may absorb microwave energy and convert it into heat, thereby providing some heat to the cooking plates.

Preferably, affixed to the first cooking plate 24 and disposed between the first cooking plate 24 and the first housing member 12 is a first heating element 28. Preferably, affixed to the second cooking plate 26 and disposed between the second cooking plate 26 and the second housing member 14 is a second heating element 30. Such heating elements are preferably constructed of microwave absorptive material. A preferred material may include a mineralized silicone, which is composed of an even distribution of a mineralized composite blended into a silicone substrate. This may create a heating element that exhibits high performance qualities and is preferably suitable for prolonged or repeated exposure to microwave energy. Such mineralized silicone material is preferably energized when the microwave oven is operating and can reach temperatures of at least 200 degrees Celsius. It is contemplated that the heating elements may be affixed in a variety of ways, not all of which are described herein. For example, in one embodiment, the elements may be bonded onto the cooking plates by a process similar to co-molding. In such a process, the plate may be manufactured from its own mold, which plate may then be inserted into a separate mold, where the mineralized silicone may then be added and then heated and allowed to set. Another alternative method for affixing the heating elements to the cooking plates may be by a chemical bonding process. In a further alternative, the heating elements may be affixed to the housing members in any of the ways described above, or in any manner that would be apparent to those of ordinary skill in the art.

In an alternative embodiment, the microwavable cooking apparatus 10 may include at least one spring 32 disposed between at least one of the first and second cooking plates and one of the first and second housing members. Such spring 10 may preferably permit the attached cooking plate to move in a direction perpendicular to the surface of such plate. The spring 10 may be designed so as to allow movement of the cooking plate upon placement of food within the apparatus. Therefore, the interior portion 22 is preferably designed to be deep enough to permit the plates to move to a certain position when foodstuffs of a certain size are placed between the cooking plates. The spring 10 may be formed into any shape and constructed of any material. A preferred embodiment of the apparatus may include conical springs made out of silicone, as depicted in FIG. 2. The conical shape is preferable because it may allow for less resistance upon initial compression, with increasing resistance as the pressure is increased. Such spring shape may also allow for greater compression, and therefore greater cooking volume. Silicone is a preferred material because of its insulating properties and high heat resistance. If metal springs are used, such springs may need to be coated with insulating material, such that the metal is shielded from direct contact with the microwave energy.

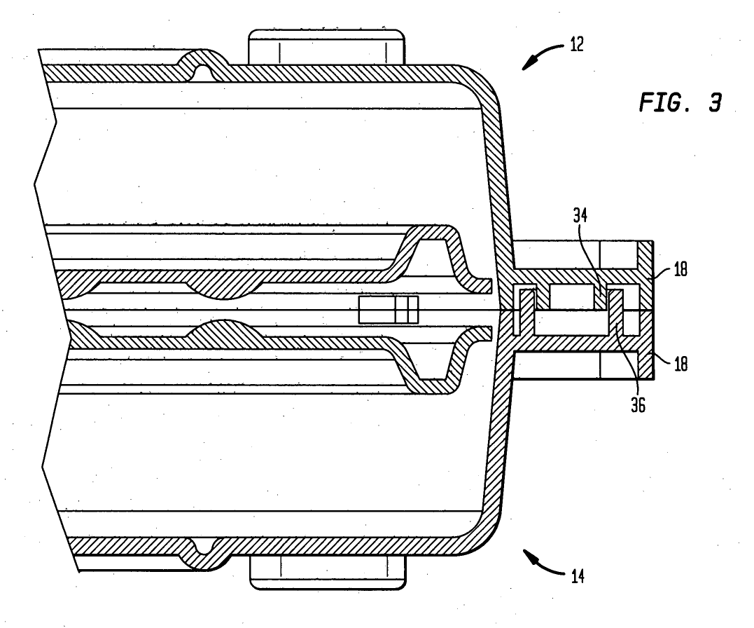

In order to secure the first housing member 12 to the second housing member 14, a securing means may be provided. Many different types of securing means may be utilized, as would be apparent to those of ordinary skill in the art. In a preferred embodiment, such securing means may be integral with a handle 18. As illustrated in FIG. 3, a small interlocking cylinder 34 may be disposed on a handle 18, while a large interlocking cylinder 36 may be disposed on another handle 18. Such interlocking cylinders may be configured such that the small interlocking cylinder 34 fits inside the large interlocking cylinder 36 while the first housing member 12 is in engagement with the second housing member 14. Preferably the interlocking cylinders are designed with tight tolerances so that the housing members may be firmly secured and may resist forces which might otherwise dislodge such housing members. Alternatively, an additional mechanical element may be included to ensure that the housing members remain together.

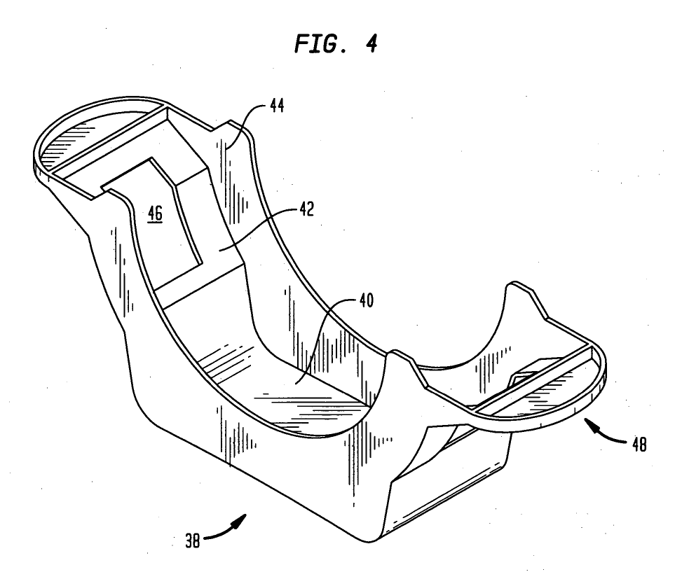

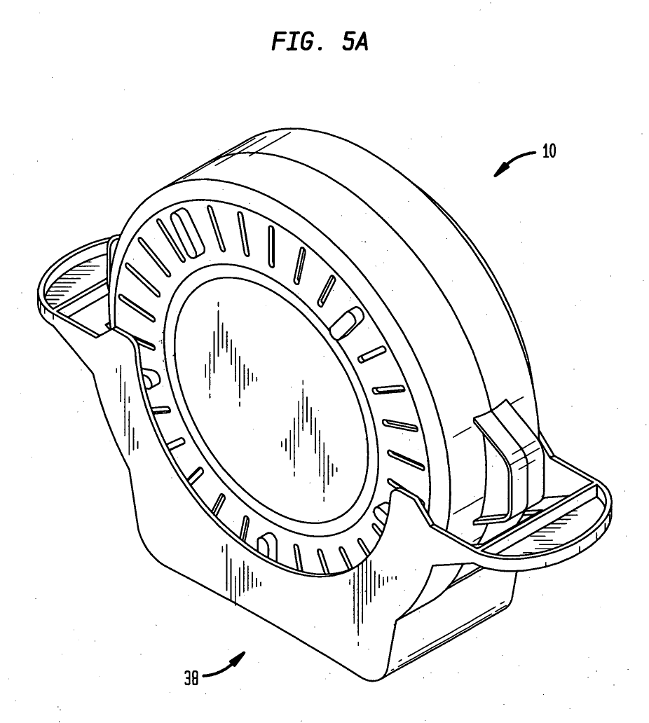

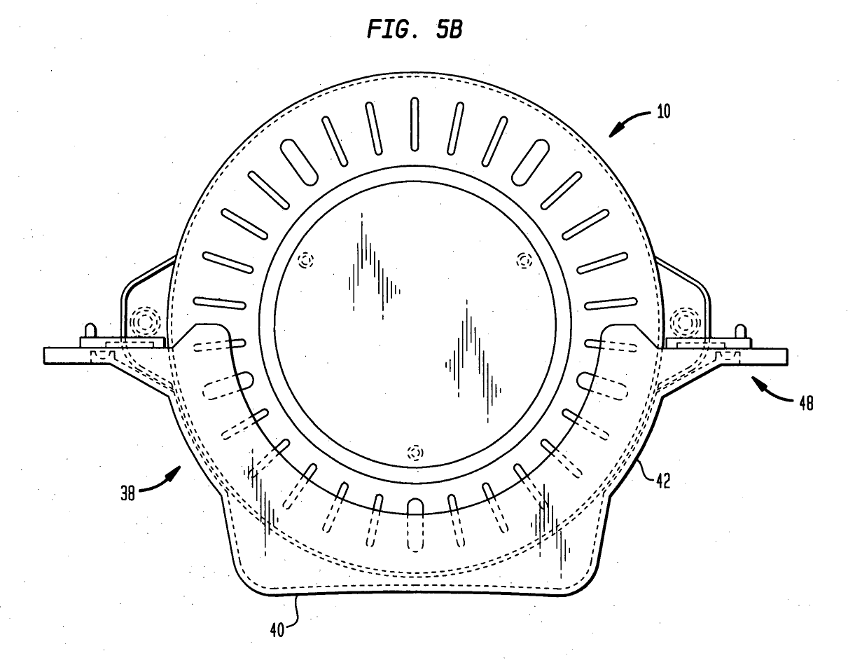

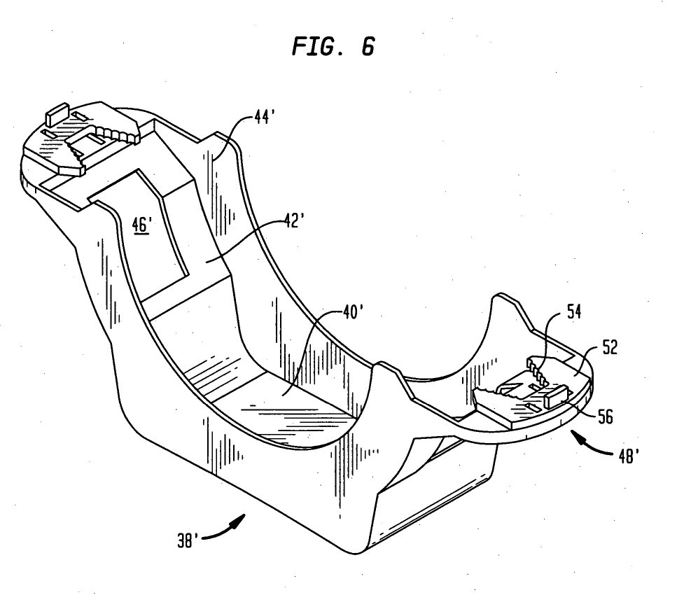

FIGS. 4 to 5b depict a support base 38 in accordance with one aspect of the present invention. An alternate embodiment is shown in FIGS. 6 to 8b and is referred to as support base 38′. Elements in FIGS. 6 to 8b which correspond to elements in FIGS. 4 to 5b are labeled with corresponding reference numerals with a prime indicator.

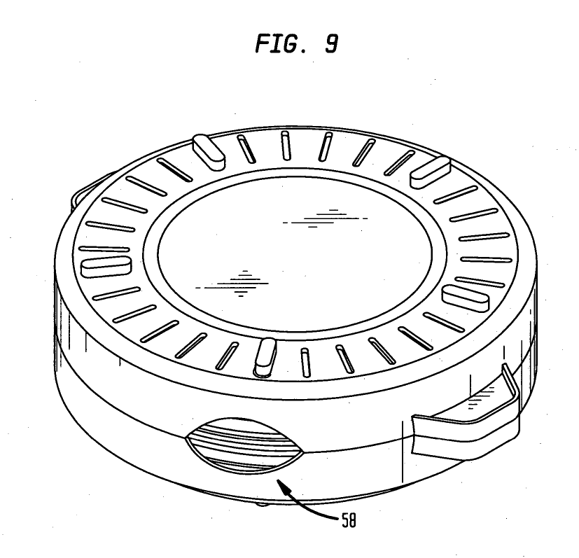

Referring to FIG. 4, the support base 38 is preferably designed as a single manufactured unit and constructed of a high heat resistant polymer. The support base 38 may contain a drip tray 40 which is integral with the support base 38. Alternatively, the drip tray 40 may be removable. In order to direct expelled grease and other liquids emanating from the cooking food into the drip tray 40, the housing members may define an opening 58, as illustrated in FIG. 9, which is preferably positioned above such drip tray 40. The support base 38 may also be designed with complimentary supporting surfaces 42, which are designed to complement the shape of the exterior surfaces 16 of the housing members in such a way that the supporting surfaces 42 may provide vertical support to apparatus 10 in its vertical orientation, as depicted in FIGS. 5a to 5b. Preferably, the complimentary supporting surfaces 42 are positioned in such a way that the apparatus 10 may be supported up and away from the drip tray 40. Additionally, vertical supporting sides 44 may be provided, in order to provide lateral support to the apparatus 10 in its vertical orientation.

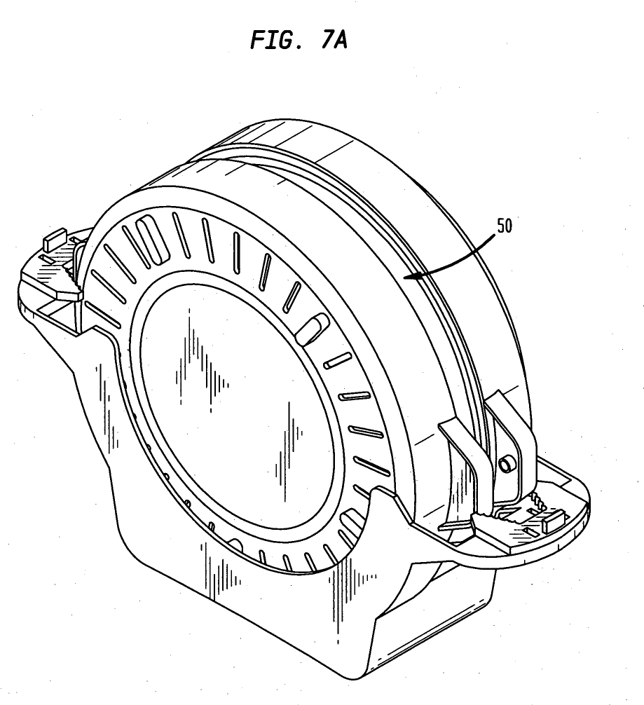

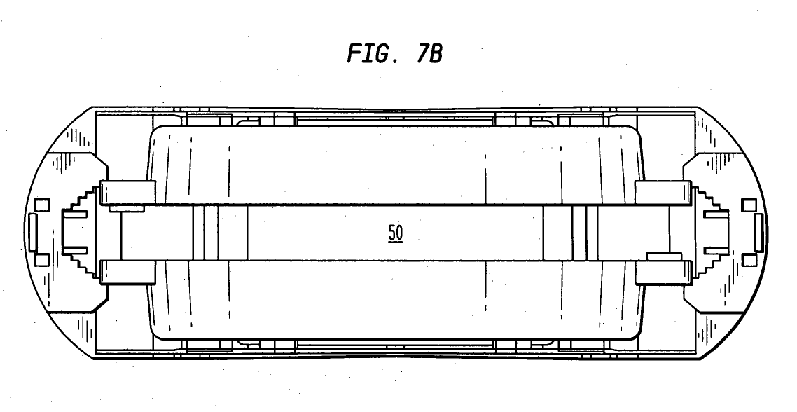

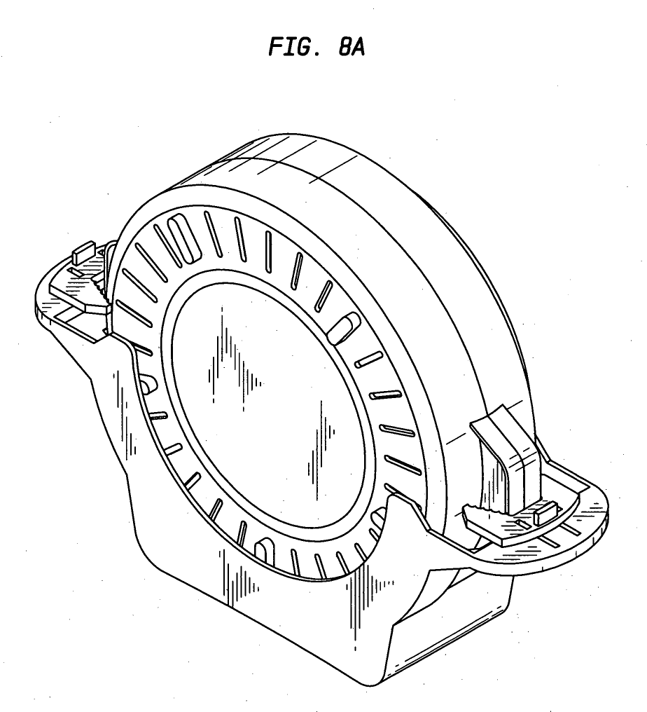

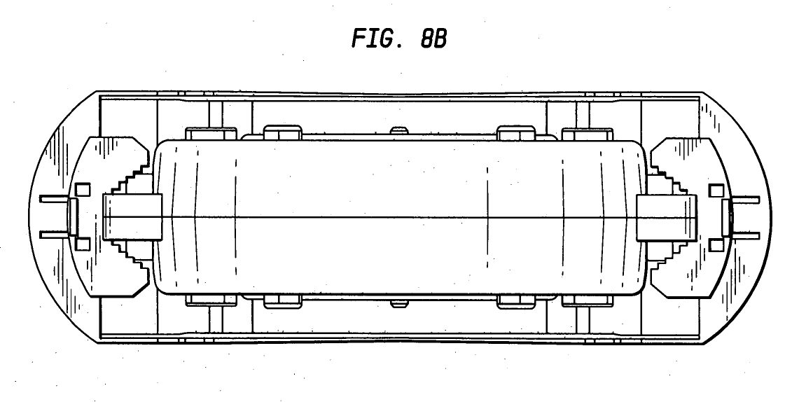

According to the embodiment depicted in FIGS. 4 to 5b, the distance between the vertical supporting sides 44 may correspond to the width of the apparatus 10 when the first housing member 12 is in engagement with the second housing member 14. Such distance may also be designed with a relatively tight tolerance so that the apparatus 10 may be firmly secured within the support base 38, while still allowing for easy insertion and removal. In an alternative embodiment, depicted in FIGS. 6 to 8b, the distance between vertical supporting sides 44′ may be larger than the distance between the vertical supporting sides 44 of the embodiment of FIG. 4. In this way, the apparatus 10 may fit within the support base 38′ while still allowing for a gap 50 between the housing members, as illustrated in FIGS. 7a and 7b. Such gap 50 may allow differently sized foodstuffs to be captured between the cooking plates. The size of the gap 50 may be controlled by adjustment means 52. In the embodiment depicted in FIGS. 6 to 8b, the adjustment means 52 consists of a single manufactured piece which is slidably mounted onto a projection 48′. The adjustment means 52 further includes ratcheting teeth 54 and a tab 56. The ratcheting teeth 54 are adapted to engage the handles 18, whereby they may secure the apparatus 10 with a gap 50 of a selectable size, as illustrated in FIGS. 7a and 7b. The ratcheting teeth may be configured in such a way that the gap 50 may be closed by sliding the adjustment means 52 towards the apparatus 10, as shown in FIGS. 8a and 8b. The tab 56 may protrude from the adjustment means 52 and may be adapted to allow a user to grip such tab 56, in order to slide the adjustment means 52.

Other gap adjustment means may be provided, as would be apparent to those of ordinary skill in the art. For example, an alternative gap adjustment means may be composed of interlocking pieces disposed on the housing members. In this manner, a piece from one housing member may be adapted to engage a piece from the other housing member. For instance, a tab extending from one housing member may be adapted to slide through a slot on the other housing member. The gap may then be adjusted by the provision of ratcheting teeth on such tab, or the slot may include a clamping or locking mechanism for securing the tab at a selected position.

The gap adjustment means 52 discussed above may also be used in order to vary the pressure applied to the contained foodstuffs. For instance, by incrementally reducing the size of the gap between the housing members, the cooking plates may exert more pressure on the contained foodstuffs. Additionally, if springs 32 are provided, such space adjustment may cause the springs 32 to further depress, which may also increase the pressure exerted on the contained foodstuffs. This pressure varying function may be useful for different desired cooking effects, such as, for example, making panini sandwiches or melts.

Referring again to FIG. 4, the support base 38 may also include openings 46 which correspond to the dimensions of the handles 18. Such openings 46 preferably allow the handles 18 to fit therethrough, thereby preventing interference between the handles 18 and the support base 38 while the apparatus 10 is being supported. The support base 38 may also include projections 48, which may act as handles while the apparatus 10 is disposed within the support base 38.

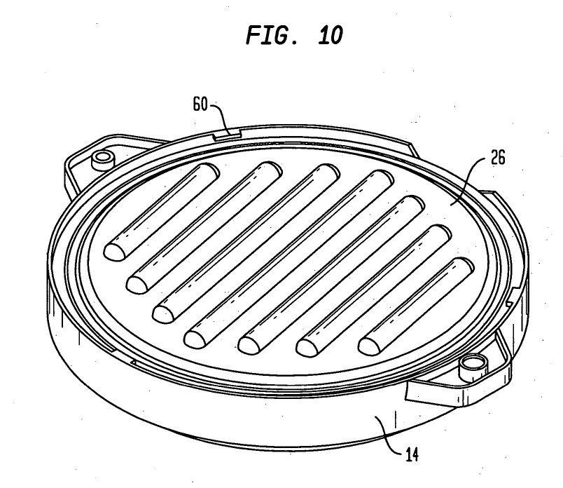

FIG. 10 is a perspective view of the microwavable cooking apparatus with the first housing member 12 removed. The second cooking plate 26 is shown disposed within the second housing member 14. Many different means may be utilized to secure the second cooking plate 26 to the second housing member, as would be apparent to those of ordinary skill in the art. One of such means includes the provision of a plurality of tabs 60. The tabs 60 may be connected to the second housing member 14 and oriented so that they stick out over the second concavity 15, thereby preventing the second cooking plate 26 from dislodging from the second housing member 14. In another embodiment of the invention, springs 32 may be provided. Such springs 32, in addition to the function discussed above, may also help in securing the cooking plate to the housing element by forcing such cooking plate against the tabs 60.

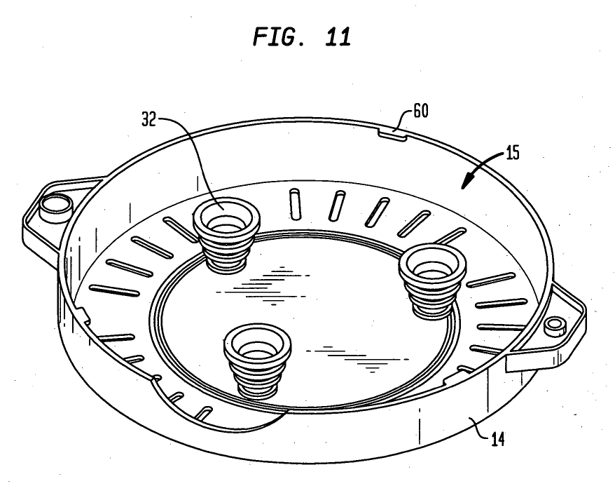

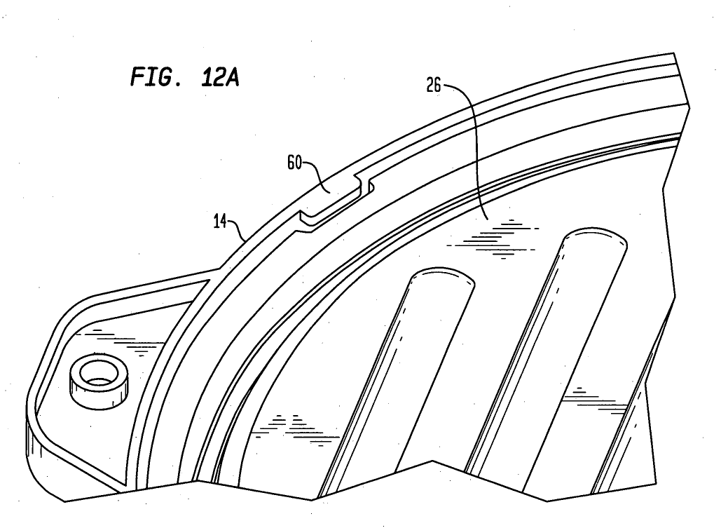

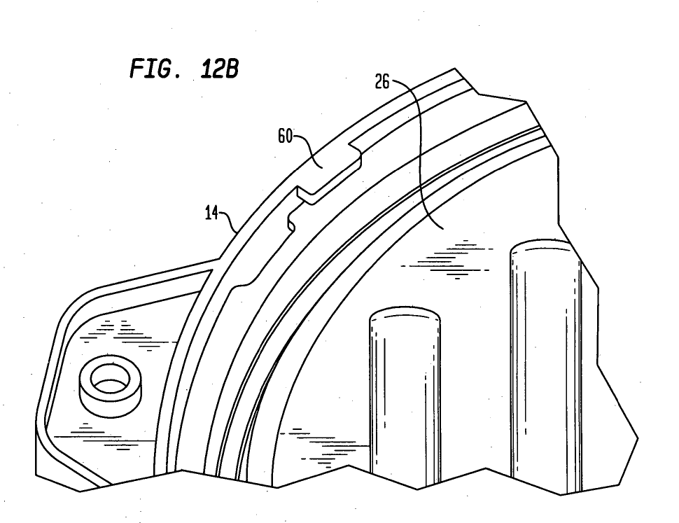

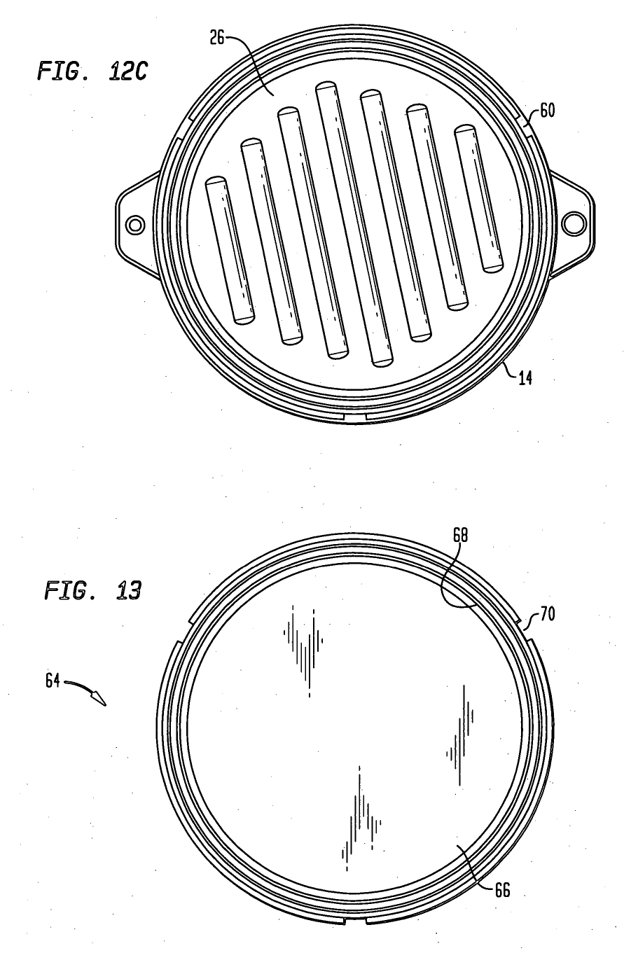

In one embodiment, the second cooking plate 26 may be permanently mounted to the second housing member 14. In an alternative embodiment, the second cooking plate 26 may be detachably mounted to the second housing member 14. FIG. 11 depicts the microwavable cooking apparatus of FIG. 10 with the second cooking plate 26 removed. In the latter embodiment, wherein the cooking plates are detachable, a variety of means may be employed to detach the second cooking plate 26 from the second housing member 14. In one embodiment, the second cooking plate 26 may include notches 70 corresponding to the location, size, and shape of the tabs 60. Examples of cooking plates with notches 70 are shown in FIGS. 13 to 18. In order to remove the second cooking plate 26 in accordance with this embodiment, the plate may be rotated until the notches 70 align with the tabs 60, as illustrated in FIG. 12a. In order to secure the second cooking plate 26 in accordance with this embodiment, the plate may be rotated until the notches 70 no longer align with the tabs 60, as illustrated in FIGS. 12b to 12c. In an alternative embodiment, the plates may or may not include notches 70, but at least one of the tabs 60 may be retractable.

The same means for securing the second cooking plate 26 to the second housing member 14 discussed above may also be utilized in order to secure the first cooking plate 24 to the first housing member 12. Additionally, the same means for detaching the second cooking plate 26 from the second housing member 14 discussed above may also be utilized in order to detach the first cooking plate 24 from the first housing member 12. Furthermore, springs 32 may or may not be provided between the first cooking plate 24 and the first housing member 12. Therefore, in accordance with the present invention, any combination of securing means, detaching means, and springs 32 may be utilized with respect to either, neither, or both of the cooking plates and the housing members. For example, both first and second cooking plates may be detachably mounted to the first and second housing members, while springs 32 may be provided between both the first cooking plate 24 and first housing member 12 and between the second cooking plate 26 and second housing member 14. Alternatively, springs 32 may only be provided between the first cooking plate 24 and the first housing member 12, while the second cooking plate 26 may be detachably mounted to the second housing member 14. In a further alternative, springs 32 may be provided between both the first cooking plate and first housing member and the second cooking plate and second housing member, while neither or only one of the cooking plates may be detachably mounted. Even further combinations may be utilized, as would be apparent to those of ordinary skill in the art.

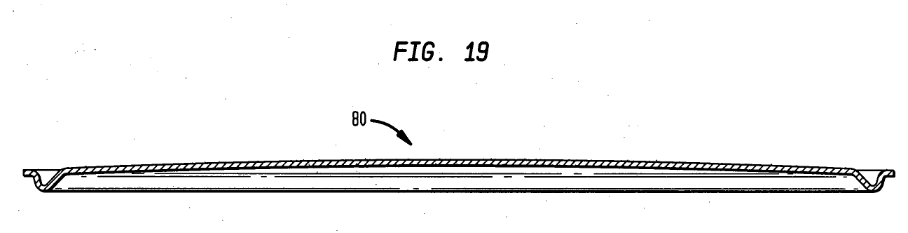

Examples of different cooking plates which are contemplated are illustrated in FIGS. 13 to 19. FIG. 13 illustrates a griddle plate 66. Such plate may include a substantially flat surface 66 surrounded by a recessed channel 68. The aforementioned notches 70 are included around the perimeter of the plate. During horizontal operation, preferably the grease and/or other liquids expelled from the cooking foodstuffs may flow into the recessed channel 68, where such may be collected for disposal after cooking. This drawing away of the liquids reduces the moisture content of the cooking foods, allowing the finished foods to be browned and crispier, as well as removing unwanted and/or unhealthy materials from the finished product. In order to assist the flow of the liquids into the channel, the griddle plate 64 may alternatively include a substantially convex surface 80, as illustrated in FIG. 19. Preferably, the griddle plate 64 includes a non-stick coating, such as PTFE or other often employed non-stick coating.

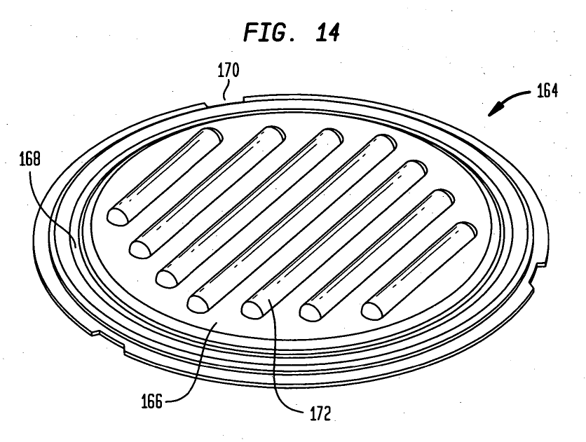

FIG. 14 illustrates a grill plate 164, which may include a substantially flat surface 166 on which may be disposed a plurality of raised, parallel ridges 172, like those often found in relation to standard grills. The preferred result of cooking with this plate is that the surface of the cooked foods will contain the traditional browned, parallel grill marks that are expected when cooking on a conventional grill. As with the previous cooking plates, the grill plate 164 is also preferably surrounded by a recessed channel 168 for the collection of grease and other liquids. In addition, the ridges 172 may serve the added function of channeling the liquids away from the cooking foodstuffs. Notches 170 may also be included around the perimeter of the plate. Additionally, as with the griddle plate 64, the grill plate 164 may include a substantially convex surface 80, on which may be disposed the raised, parallel ridges 172. Preferably, the grill plate 164 includes a non-stick coating, such as PTFE or other often employed non-stick coating.

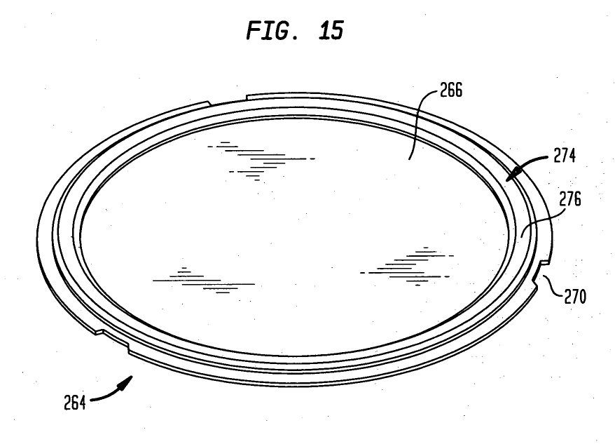

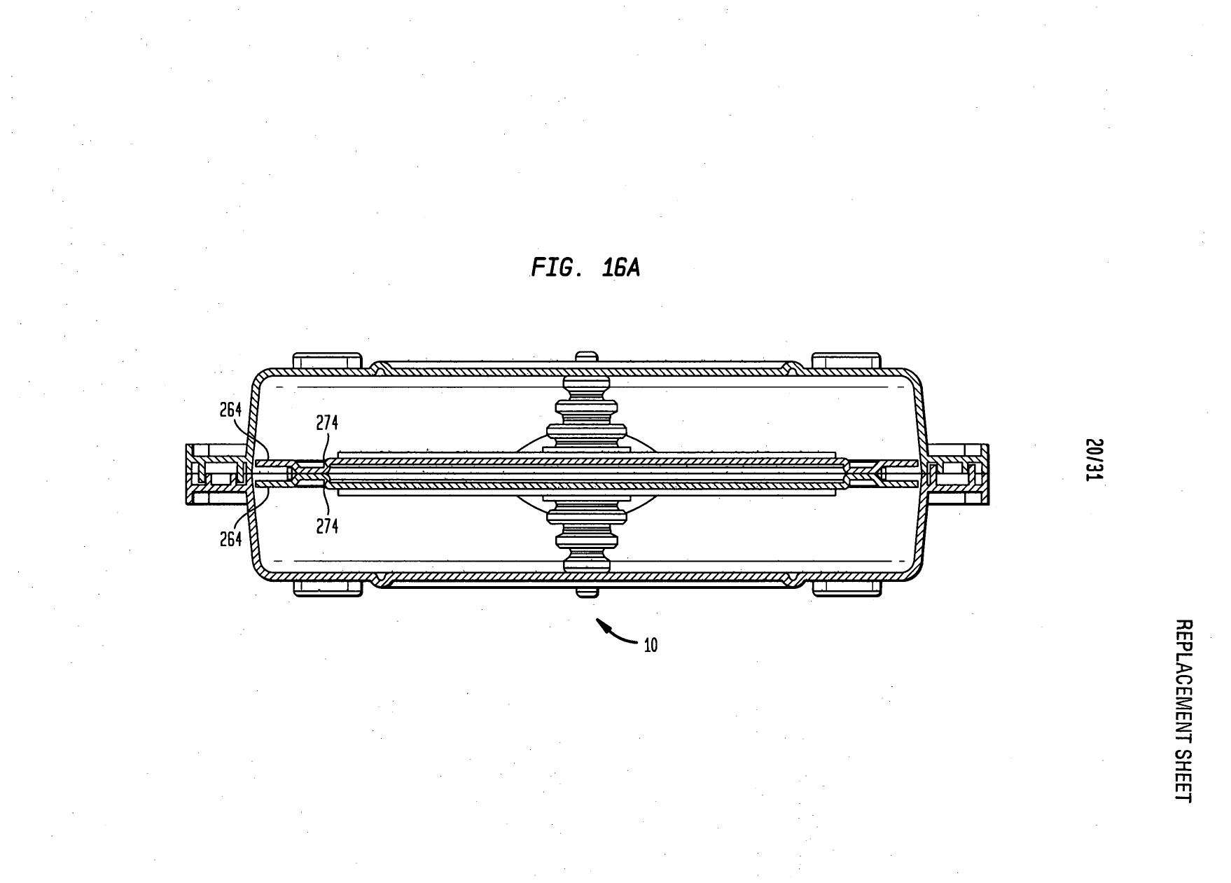

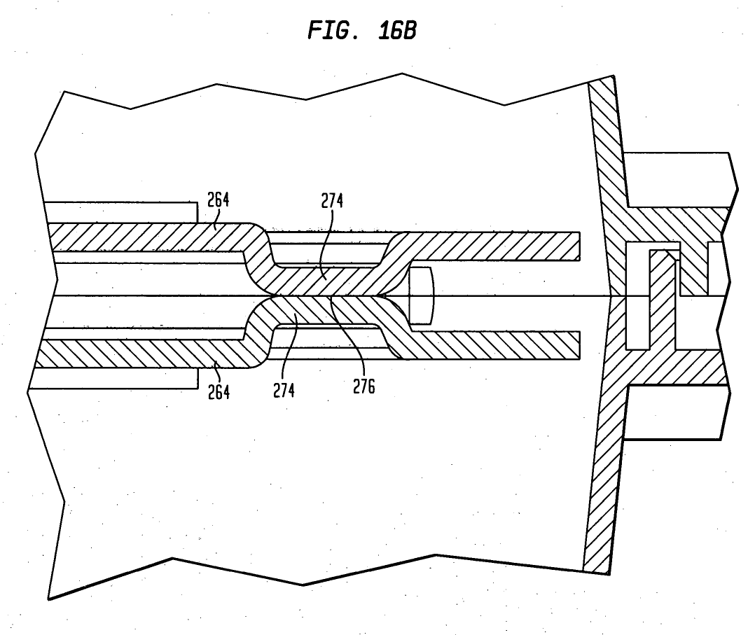

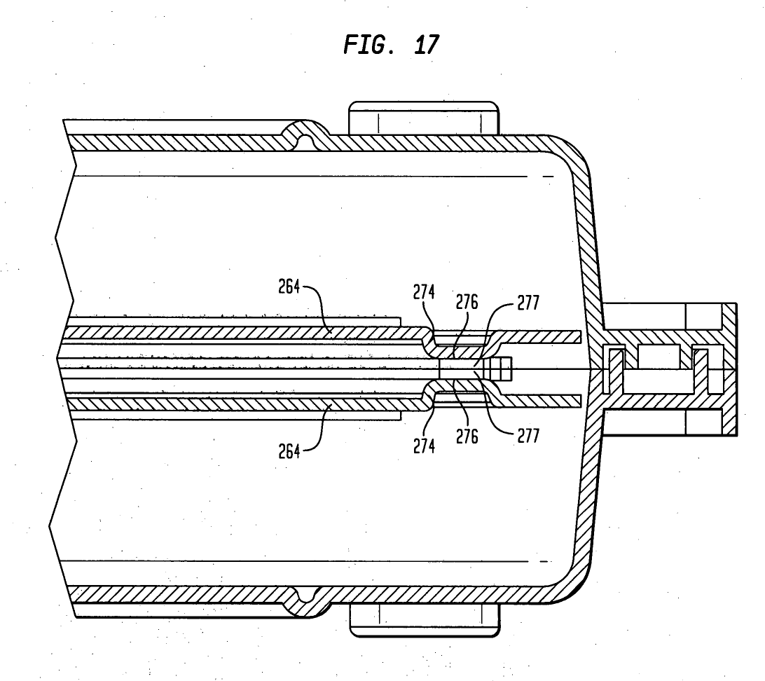

FIG. 15 illustrates a pancake plate 264, which may include a substantially flat surface 266 encircled by a raised pancake-batter retaining ridge 274. Such ridge 274 may include a top surface 276, which is adapted to engage the corresponding top surface 276 of the ridge 274 on another pancake plate 264. FIGS. 16a to 16b illustrate a preferred mode of engagement of two pancake plates 264 within the apparatus 10. The engagement of the top surface 276 of one pancake plate 264 and the top surface 276 of another pancake plate 264 preferably creates a seal, which may prevent pancake batter from spilling out from between the two plates while such plates are in contact. In order to provide a better seal, the top surfaces 276 may include a silicone ring 277 disposed thereon, as shown in FIG. 17. Such silicone ring 277 may also act a buffer that may prevent scratching or chipping of the top surfaces 276, which could potentially lead to arcing problems. As with the previous cooking plates, the pancake plate 264 may include notches 270 around the perimeter of the plate, and such plate preferably includes a non-stick coating.

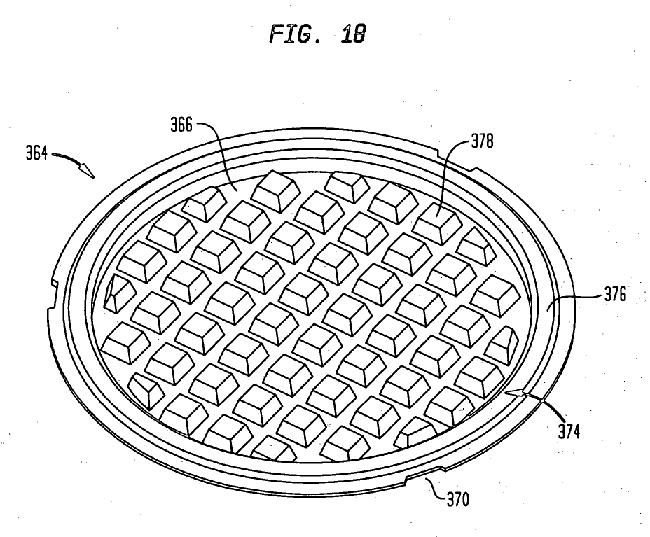

FIG. 18 illustrates a waffle plate 364, which may include a substantially flat surface 366 on which may be disposed a substantially gridded arrangement of raised protrusions 378, like those often found in relation to standard waffle plates. As with the pancake plate 264, the flat surface 366 may be encircled by a raised waffle-batter retaining ridge 374. Such ridge 374 may also include a top surface 376, which may create a seal in substantially the same manner as that depicted in FIGS. 16a to 17. Additionally, as with the previous cooking plates, the waffle plate 364 may include notches 370 around the perimeter of the plate, and such plate preferably includes a non-stick coating.

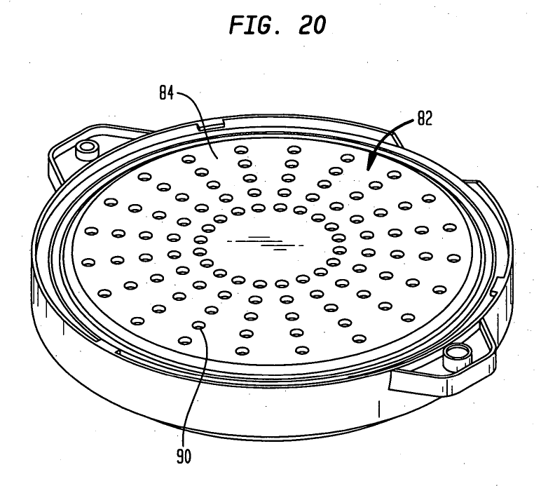

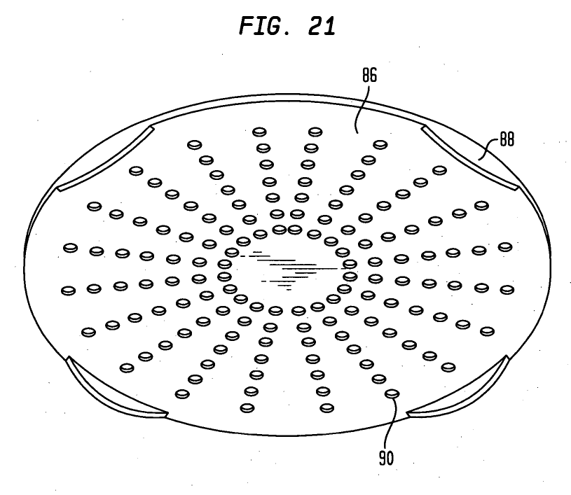

FIG. 20 is a perspective view of a microwavable cooking apparatus in accordance with an alternative embodiment of the present invention in which a steaming rack 82 is shown in engagement with the apparatus 10. Such steaming rack 82 is preferably used in conjunction with a steaming function of the invention. The steaming rack 82 may include a top surface 84, upon which foodstuffs may be placed. FIG. 21 is a perspective view of the bottom surface 86 of the steaming rack 82. The bottom surface 86 may include a plurality of feet 88 projecting perpendicularly therefrom which are preferably adapted to engage one of the cooking surfaces. Such feet 88 may be designed to raise the bottom surface 86 of the steaming rack 82 above the cooking surface upon which such steaming rack 82 is resting. In this manner, water may be placed on the cooking surface such that the water level is below the bottom surface 86 of the steaming rack 82. During cooking in a microwave oven, the cooking surface may heat up the water, which may then boil and steam such foodstuffs. The steaming rack 82 may preferably be made out of a high heat resistant polymer, metal, or some other similar material. The rack 82 may also include a plurality of holes 90, organized in any arrangement, which may allow the steam to easier contact the foodstuffs.

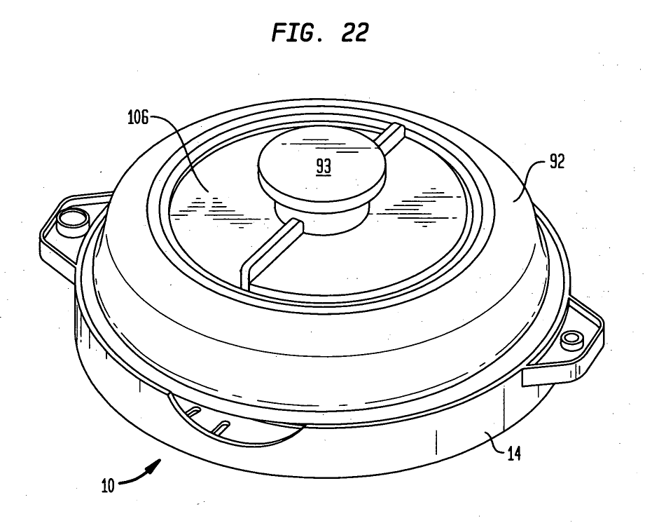

The apparatus 10 is preferably designed so that the first housing member 12 may be entirely separated from the second housing member 14, as shown in FIG. 10. In this manner, each half of the apparatus 10 may be used independently as a single cooking surface embodiment. In this mode, the apparatus may be used with or without a lid 92. FIG. 22 shows a preferred embodiment in which half of the apparatus 10, including the second housing member 14, cooperates with the lid 92. The lid 92 is preferably made a microwave reflective material, such as metal, which may prevent microwave energy from directly contacting the cooking foodstuffs while such lid 92 is being utilized. The lid 92 also preferably includes a top handle 93, to allow for easy placement and removal of the lid 92.

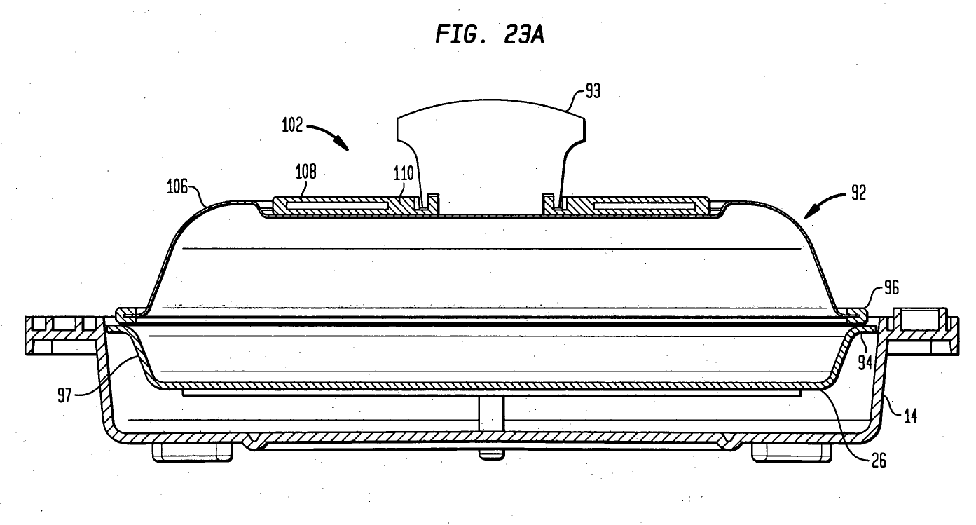

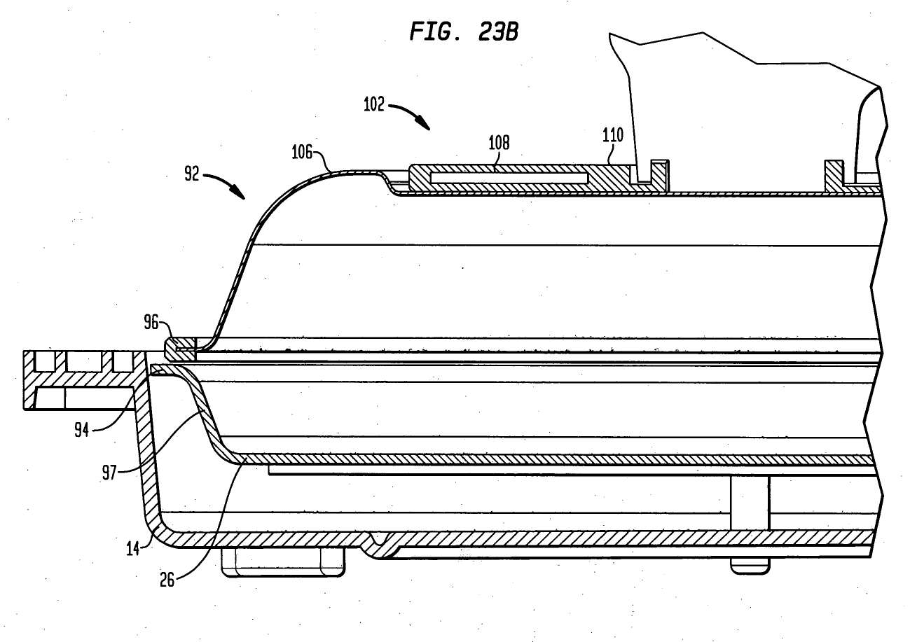

The lid 92 may be adapted to engage a rim 94 such that a seal is created thereby. The rim 94 may be located on either the second housing member 14 or the second cooking plate 26. Additionally, an insulating ring 96, preferably made out of silicone, may be provided. Such ring 96 may be affixed to either the perimeter of the lid 92 or the upper surface of the rim 94. The ring 96 preferably makes the seal between the lid 92 and the rim 94 airtight, thereby preventing the release of heat or steam. The ring 96 may also be configured in such a way that direct contact between the metal of the lid 92 and the metal of the second cooking plate 26 is prevented while the lid 92 is engaging the rim 94. As a result, repeated contact between the lid 92 and the rim 94 may not create chips in the surface material over time, which may lead to arcing problems when the apparatus 10 is exposed to microwaves. FIGS. 23a and 23b illustrate the lid 92 cooperating with the apparatus 10 according to a preferred embodiment of the invention, in which the rim 94 is located on the second cooking plate 26 and the ring 96 is affixed to the perimeter of the lid 92. The second cooking plate 26 illustrated in FIGS. 23a and 23b is a pan shaped plate, which includes a substantially flat surface and a raised edge 97 along the perimeter. As illustrated, the rim 94 may be located at the top of such raised edge 97.

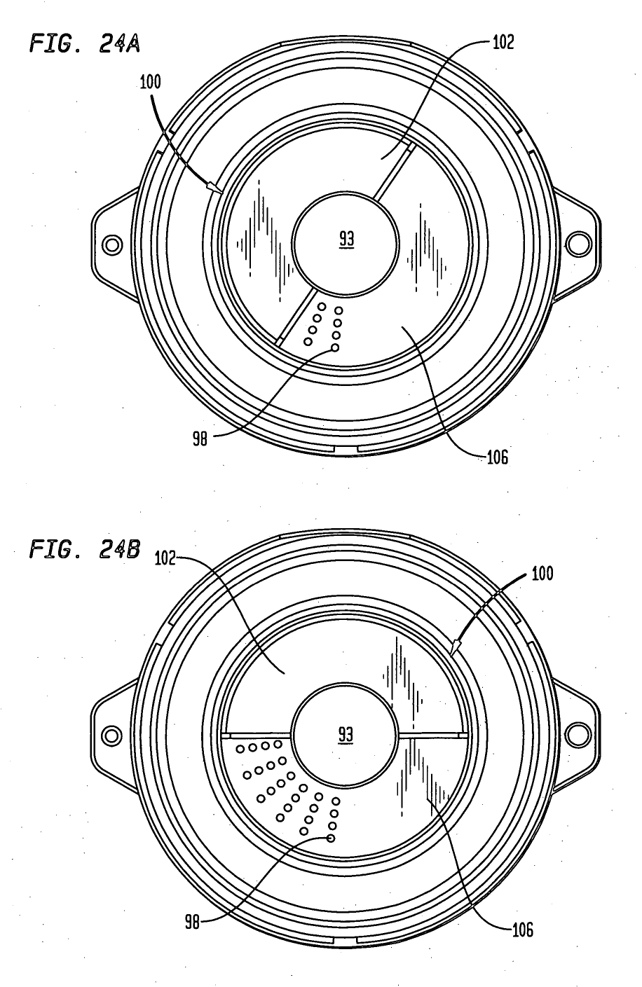

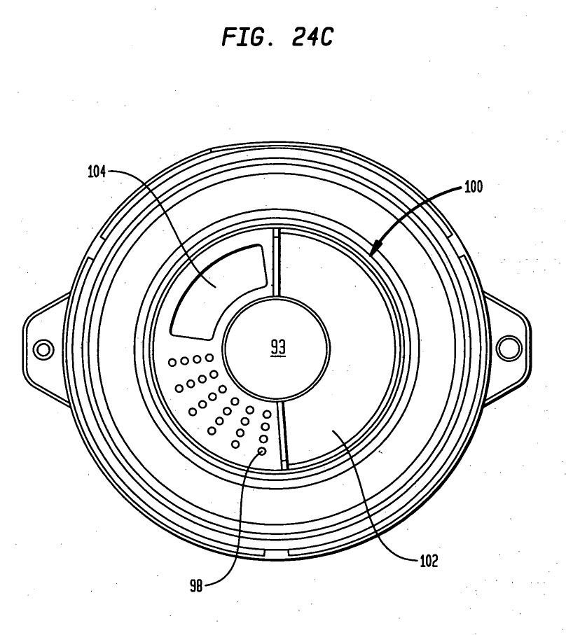

As shown in FIGS. 24a to 24c, the lid 92 may include a plurality of vent holes 98, which allow the steam and moisture expelled from the food to be released from the apparatus 10. By allowing the moisture to escape, such vent holes 98 may allow the cooking food to become crispier. The apparatus may also include a vent hole adjusting means 100. In one contemplated embodiment, the top handle 93 on the lid 92 may be attached to a turning plate 102, located on top of the lid 92. Such turning plate 102 may be permitted to rotate about the center of the lid 92 by twisting the aforementioned top handle 93. Such twisting may selectively cover or uncover various vent holes 98 in the lid 92, as illustrated in FIGS. 24a to 24c. In order to make this function more user friendly, a set of markings or fixed positions may be provided on the lid 92, in order to indicate which setting to use for each desired cooking effect. In this regard, the various settings with respect to the vent holes 98 may be used for different desired functions or cooking effects. For instance, the vent holes 98 may be closed for a baking or steaming operation. They may also be opened very wide, or the turning plate 102 may be rotated to uncover a large opening 104, in order to, for example, allow some of the microwave energy to contact the cooking food directly. Allowing microwave energy to directly contact the foodstuff being cooked may also be achieved by removing the lid 92 as a whole.

In order to prevent the microwave energy from directly striking the food when the turning plate 102 is covering the vent holes 98 and the opening 104, such turning plate 102 may be constructed of microwave reflective material. Additionally, in order to prevent scratching (and potential arcing) of the lid 92 when such turning plate 102 is rotated over the outer surface 106 of the lid 92, such turning plate 102 is preferably coated with a polymer. Therefore, a preferred embodiment of the turning plate 102 includes a metal inner plate 108 overmolded with a polymer coating 110, as illustrated in FIGS. 23a and 23b. Both the coating 108 on the turning plate 102 and the top handle 93 may be constructed of various different materials which may remain cool to the touch, in order to prevent burning the user. Suitable materials include, among others: polypropylene (PP), polysulfone (PSU), sodium polystyrene sulfonate (SPS), bulk molding compound (BMC), or polyetherimide (PEI).

Other vent hole adjusting means may be provided, as would be apparent to those of ordinary skill in the art. For example, an alternative adjusting means may include the turning plate 102 located on the underside of the lid 92. Or, alternatively, the adjusting means may consist of a turning plate 102 that is not attached to the top handle 93, but may be turned by gripping such turning plate 102. In yet another alternative, the adjusting means may consist of a shutter that slides, not necessarily in a rotational manner with respect to the handle 93, in order to open one or more apertures in the lid to a specified size.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A microwavable cooking apparatus comprising:
at least one housing member;
at least one cooking plate detachably mounted inside the housing member; and
a heating element, adapted to convert microwave energy into heat, disposed between the cooking plate and the housing member.

2. The microwavable cooking apparatus of claim 1, wherein the cooking plate includes features selected from the group consisting of a plurality of raised ridges, a substantially flat surface, a substantially convex surface, a gridded arrangement of raised waffle protrusions, or an encircling pancake-batter retaining ridge.

3. The microwavable cooking apparatus of claim 1, wherein the cooking plate includes a recessed channel.

4. The microwavable cooking apparatus of claim 1, wherein the cooking plate includes a non-stick coating.

5. The microwavable cooking apparatus of claim 1, further including a rim and a lid adapted to engage the rim, wherein the lid or the rim includes an insulating ring adapted to engage the other of the lid or rim such that direct contact between the lid and the rim is prevented.

6. The microwavable cooking apparatus of claim 5, wherein the lid includes at least one vent hole and means for adjusting the vent hole.

7. The microwavable cooking apparatus of claim 6, wherein the means for adjusting the vent hole includes a turning plate adapted to selectively cover or uncover the vent hole.

8. The microwavable cooking apparatus of claim 1 wherein the apparatus includes:
a first housing member;
a second housing member opposed to the first housing member such that an interior portion is defined therebetween;
a first cooking plate disposed within the first housing member;
a second cooking plate disposed within the second housing member;
a first heating element, adapted to convert microwave energy into heat, disposed between the first cooking plate and the first housing member; and
a second heating element, adapted to convert microwave energy into heat, disposed between the second cooking plate and the second housing member;
wherein at least one of the first and second cooking plates is detachably mounted to one of the first and second housing members.

9. The microwavable cooking apparatus of claim 8, wherein the first cooking plate and the second cooking plate oppose one another in substantially parallel planes.

10. The microwavable cooking apparatus of claim 8, further including at least one spring disposed between at least one of the first and second cooking plates and one of the first and second housing members, whereby one of the cooking plates is permitted to move in a direction perpendicular to the surface of such cooking plate.

11. The microwavable cooking apparatus of claim 8, wherein the microwavable cooking apparatus may be utilized while being situated in both horizontal and vertical orientations.

12. The microwavable cooking apparatus of claim 11, further including a support base adapted to support the apparatus in the vertical orientation.

13. The microwavable cooking apparatus of claim 12, further including a drip tray disposed within the support base and the first housing member and the second housing member define an opening adapted to permit a liquid emanating from between the cooking plates to drip into the drip tray.

14. The microwavable cooking apparatus of claim 13, wherein the drip tray is removable.

15. The microwavable cooking apparatus of claim 8, further including means for adjusting a gap between the first and second housing members.

16. The microwavable cooking apparatus of claim 15, wherein the means for adjusting the gap between the first and second housing members includes a ratcheting mechanism disposed on the support base.

17. A microwavable cooking apparatus comprising:
a first housing member;
a second housing member opposed to the first housing member such that an interior portion is defined therebetween;
a first cooking plate disposed within the first housing member;
a second cooking plate disposed within the second housing member;
a first heating element, adapted to convert microwave energy into heat, disposed between the first cooking plate and the first housing member; and
a second heating element, adapted to convert microwave energy into heat, disposed between the second cooking plate and the second housing member;
wherein the microwavable cooking apparatus may be utilized while being situated in both horizontal and vertical orientations.

18. The microwavable cooking apparatus of claim 17, further including at least one spring disposed between at least one of the first and second cooking plates and one of the first and second housing members, whereby one of the cooking plates is permitted to move in a direction perpendicular to the surface of such cooking plate.

19. The microwavable cooking apparatus of claim 17, wherein at least one of the first and second cooking plates is detachably mounted to one of the first and second housing members.

20. The microwavable cooking apparatus of claim 17, further including at least one rim and a lid adapted to engage the rim, wherein the lid or the rim further includes an insulating ring adapted to engage the other of the lid or rim such that direct contact between the lid and the rim is prevented.

21. The microwavable cooking apparatus of claim 20, wherein the lid includes at least one vent hole and means for adjusting the vent hole, wherein the means for adjusting the vent hole includes a turning plate adapted to selectively cover or uncover the vent hole.

22. The microwavable cooking apparatus of claim 17, further including a support base adapted to support the apparatus in the vertical orientation.

23. The microwavable cooking apparatus of claim 22, further including a drip tray disposed within the support base and the first housing member and the second housing member define an opening adapted to permit a liquid emanating from between the cooking plates to drip into the drip tray.

24. The microwavable cooking apparatus of claim 17, further including means for adjusting a gap between the first and second housing members, wherein the means for adjusting the gap between the first and second housing members includes a ratcheting mechanism disposed on the support base.

25. A microwavable cooking apparatus comprising:
a first housing member;
a second housing member opposed to the first housing member such that an interior portion is defined therebetween;
a first cooking plate disposed within the first housing member;
a second cooking plate disposed within the second housing member;
a first heating element, adapted to convert microwave energy into heat, disposed between the first cooking plate and the first housing member;
a second heating element, adapted to convert microwave energy into heat, disposed between the second cooking plate and the second housing member; and
at least one spring disposed between at least one of the first and second cooking plates and one of the first and second housing members, whereby one of the cooking plates is permitted to move in a direction perpendicular to the surface of such cooking plate.

26. The microwavable cooking apparatus of claim 25, wherein at least one of the first and second cooking plates is detachably mounted to one of the first and second housing members.

27. The microwavable cooking apparatus of claim 25, further including at least one rim and a lid adapted to engage the rim, wherein the lid or the rim further includes an insulating ring adapted to engage the other of the rim or the lid such that direct contact between the lid and the rim is prevented.

28. The microwavable cooking apparatus of claim 27, wherein the lid includes at least one vent hole and means for adjusting the vent hole.

29. The microwavable cooking apparatus of claim 25, wherein the microwavable cooking apparatus may be utilized while being situated in both horizontal and vertical orientations.

30. The microwavable cooking apparatus of claim 29, further including a support base adapted to support the apparatus in the vertical orientation, the support base having a drip tray, and the first housing member and the second housing member define an opening adapted to permit a liquid emanating from between the cooking plates to drip into the drip tray.

31. The microwavable cooking apparatus of claim 25, further including means for adjusting a gap between the first and second housing members, wherein the means for adjusting the gap between the first and second housing members includes a ratcheting mechanism disposed on the support base.
